(19) United States
(12) Patent Application Publication
(10) Pub. No.: US 2009/0163272 A1
(43) Pub. Date: Jun. 25, 2009

(54) CONNECTED GAMING

(75) Inventors: Nicholas Robert Baker, Cupertino, CA (US); Dawson Yee, Bellevue, WA (US); James E. Allard, Seattle, WA (US); Todd Eric Holmdahl, Redmond, WA (US); Mark D. VanAntwerp, Seattle, WA (US); David Sebastien Alles, Seattle, WA (US); Steven Drucker, Bellevue, WA (US); David Hendler Sloo, Menlo Park, CA (US); Curtis G. Wong, Medina, WA (US); Adam Tipton Berns, Bellevue, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 11/963,196

(22) Filed: Dec. 21, 2007

(51) Int. Cl. A63F 9/24; G06F 17/00

(52) U.S. Cl. 463/29; 463/42; 463/43

(57) ABSTRACT

Systems and methods are provided that facilitate a connected gaming experience for multiple players utilizing multiple disparate devices. A game service affords playing a game over a communication framework which can include wired and wireless local area and wide area networks, as well as access to a global positioning system. The game service allows users to play a game in multiple devices, seamlessly switching devices at desired times and locations. In addition, the game service affords community-driven development of a game, as well as customization, through the communication framework. The latter also facilitates exchange of various contents among players, and between a player and the game service: (a) news, (b) advertising, (c) alerts, and (d) participant's real-world positioning information. Real-world embedding into a game is facilitated by the game service in combination with global tracking information received through the communication framework.

### TECHNICAL FIELD

The subject specification relates in general to gaming, and more particularly to gaming among disparate players and devices connected to a game service, wherein players can exchange information within and outside the game service context.

### BACKGROUND

The confluence of advances in telecommunications and information technology has resulted in rich content being accessible from a variety of communication devices. The pervasiveness of data in the household, the workplace, and the community continues to grow. In particular, the virtual mobile office has become a reality, and it has allowed workers to maintain the pace with newly developed economical forces by providing workers with a steady flow of work related data and access to tools for processing that data and acting upon the results of the processing. The degree of connectivity of a household has developed to a point that accessing services like banking, purchasing of entertainment—including air tickets and hotel reservations, movies and music—is commonplace.

Yet, certain areas that can commercially benefit from the aforementioned connectivity, such as gaming, have marginally harnessed the available rich connectivity. Gaming industry in particular has primarily focused most development efforts on gaming platforms, with games largely being platform specific. Therefore, a gaming experience is typically limited. On the other hand, a class of deviceless games has partially harnessed connectivity: massively multiplayer on-line games exploit connectivity but rely heavily on desktop or laptop computers as a gaming interface, which significantly limits the commerciality of the game as a large segment of gamers are early adopters of technology interested in technologically edgy and varied devices for gaming. Thus, the rich connectivity that has dramatically changed the modern workplace through edge technologies and devices has yet to be exploited in gaming.

### SUMMARY

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

Systems and methods disclose in the subject specification facilitate a connected gaming experience for multiple players utilizing multiple disparate devices. A game service provides for playing a game over a communication framework, which can include wired and wireless local area and wide area networks, as well as access to a location system. The game service allows users to play a game in multiple devices, seamlessly switching devices at desired times and locations during a specific gameplay. Switching among devices can take place synchronously or asynchronously, the latter entailing playing disparate game challenges in disparate devices. Prior to a participant playing a game, the participant can register in the game service and can register a set of devices to employ during gameplay. Registration of devices can allow game optimization according to resources available to the device. Such optimization can preserve user experience when switching devices.

Through the communication framework, the game service also can enable community-driven development of a game, as well as customization of various aspects of the game such as features of characters, spaces, and music and sounds. Additionally, the communication framework facilitates exchange of various contents among players, and between a player and the game service; namely: (a) news, (b) advertising, (c) alerts, and (d) participant's real-world positioning information. The rich connectivity provided by the game service in combination with the communication framework can be exploited play cooperative games that promote development of real-world skills; skills that can be transferred among players and among games.

Connected gaming, e.g., the reach connectivity among players and devices, also facilitates real-world embedding into a game. Such embedding can exploit global tracking information as well as real-world aspects captured in proximity of mobile players. Such rich information is received at the game service through the communication framework and translated into metadata, which can be incorporated into a game's code through classes, objects, and methods describing the code.

To the accomplishment of the foregoing and related ends, the following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF THE DRAWINGS

FIG. 1 is a block diagram of an example system that provides a service-based, connected gaming experience among multiple players and multiple devices according to aspects disclosed herein.

FIGS. 2A and 2B are block diagrams that illustrate, respectively, detailed example architectures of a registration component and a code management component in accordance with aspects described in the subject specification.

FIG. 3 illustrates a player's game play in which multiple challenges are played through connected gaming in multiple devices at disparate times and a plurality of location in space.

FIG. 4 is a block diagram of an example system that facilitates customization of a game for a player's device.

FIG. 5 illustrates example displays of advertisement, news, or information in a game display according to aspects disclosed in the subject specification.

FIG. 6 is a block diagram of an example system that facilitates disclosing information among users in a connected gaming environment.

FIG. 7 illustrates a block diagram of an example system for community development of a game in a connected gaming environment.

FIG. 8 illustrates an example system that facilitates transferring gaming skills among games and players.

FIG. 9 illustrates a block diagram of an example system for a collaborative play group that aims at building a player's real world skills.

FIG. 10 illustrates an example system in which a game is embedded in the real world according to an aspect disclosed herein.

FIG. 11 illustrates an example system that facilitates access to real world location of specific player(s) within a game community or associates of a player within the community.

FIG. 12 presents a flowchart of an example method for playing a game within a connected gaming environment.

FIG. 13 is a flowchart of an example method for switching devices and locations while playing a game within a connected gaming environment.

FIG. 14 presents a flowchart of an example method for developing a game within a connected gaming environment.

FIG. 15 is a flowchart of an example method for developing inter-personal skills through the accomplishment of a mission among multiple players in a connected gaming environment.

FIG. 16 presents a flowchart of an example method for identifying real-world positioning of a set of players within a game community.

FIG. 17 presents a flowchart of an example method for real-world embedding of a game within a connected gaming environment.

FIGS. 18 and 19 illustrate computing environments for carrying out various aspects described herein.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present innovation.

As used in the subject specification, the terms “object,” “module,” “component,” “system,” “service,” “framework,” “store,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As employed herein, the terms “player,” “participant,” “agent,” or “user” generally refer to a human entity (e.g., a single person or group of people) that plays, participates in, or uses a computer-implemented game, as possess access to computer-related communication infrastructure, computer-related systems, electronic devices, portable or otherwise, or any combination thereof. Such terms are hereinafter employed interchangeably.

The subject matter described herein includes systems and methods that facilitate a connected gaming experience for multiple players utilizing multiple disparate devices. A game service affords playing a game over a communication framework which can include wired and wireless local area and wide area networks, as well as access to a global positioning system. The game service allows users to play a game in multiple devices, seamlessly switching devices at desired times and locations. In addition, the game service affords community-driven development of a game, as well as customization, through the communication framework. The latter also facilitates exchange of various contents among players, and between a player and the game service: (a) news, (b) advertising, (c) alerts, and (d) participant's real-world positioning information. Real-world embedding into a game is facilitated by the game service in combination with global tracking information received through the communication framework. Such aspects are next described in greater detail.

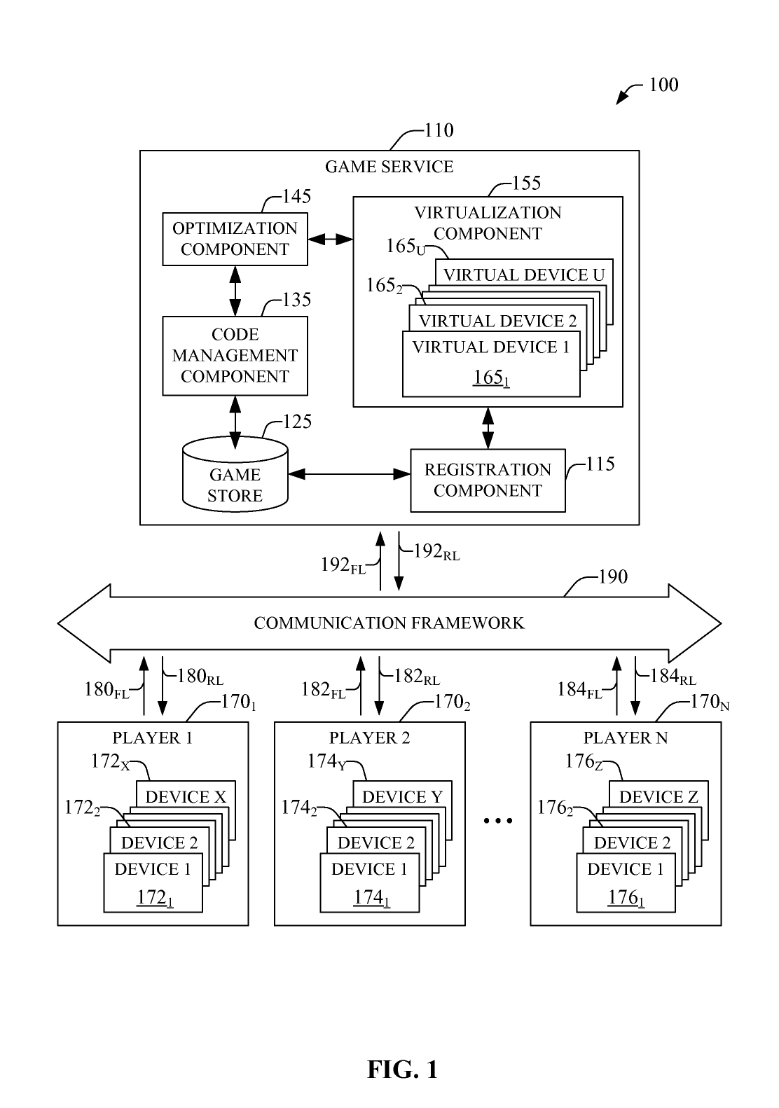

FIG. 1 is a block diagram of a system 100 that provides a service-based, connected gaming experience among multiple players and multiple devices. Game service 110 relies on various components to deliver the connected gaming experience. A registration component 115 registers players 170₁-170_{N}, games and devices {172₁-172_{X}}, {174₁-174_{Y}}, to {176₁-176_{Z}} that the players utilize to play a game; locations (e.g., home, work, vehicle) associated to a player can be registered as well. Examples of devices that can be registered with game service 110 are a desktop computer, a game console, a television set, a cellular/smart phone, a pilot digital assistant (PDA), smart glasses with embedded display technology, and so on. A game can be stored in a game store 125, and is played by the game service 110 users through a communication framework 190, which also facilitates communication among players and other network(s) that the game service 110 can utilize to provide features for the connected gaming experience.

The communication framework 190 includes a communication channel (not shown) accessed via a forward link (FL), such as 180_{FL}, 182_{FL}, or 184_{FL}, to convey traffic (e.g., data, commands) and control (e.g., passwords, payment information for applicable fees the game service can charge, and so on) from players to the channel. (Multiple FLs are illustrated with FL 192_{FL}.) Traffic and control from game service 110 to the communication channel is accomplished through reverse links (RLs), illustrated with RL 192_{RL} which includes RL 180_{RL}, 182_{RL}, and 184_{RL}. A communication channel can correspond to the infrastructure associated with a wired local area or wide area network, such as a fiber optic network, a twisted-pair network, a T1/E1 line-based network or other links of the T-carrier/E carrier protocol, or a wireless local area or wide area network (operating through multiple protocols such as ultra-mobile band (UMB), long term evolution (LTE), etc.). Additionally, communication framework 190 can comprise base stations for wireless communications, which include transceivers, associated electronic devices for modulation/demodulation, and switches and ports to connect to a backbone network for backhaul communication such as in the case of packet-switched communications.

Game store 125 can include games of disparate nature, such as trivia and brain training games (e.g., puzzles, memory reinforcement games), simulation games, role playing games, and so forth. Stored games can be graphic intensive (such as Halo®, Jericho™, Call of Duty®, World of Warcraft©, The Sims™, Civilization®, Simcity™, Grand Theft Auto, FIFA Street, Doom™, etc.) or text intensive (e.g., crosswords, sudoku, play by email (PBeM) games like Diplomacy, and so on), or include any combination thereof. It is noted that players 170₁-170_{N} registered with game service 110 can upload their own games into game store 125; registration component 115 can ensure that appropriate licensing is available for such upload.

In one aspect, games in game store 125 are coded following an object-oriented or a component-oriented paradigm within a runtime system (e.g., Microsoft®.NET Common Language Runtime (CLR)), which allows code management component 135 to reduce the classes and associated metadata in a game's source code to a platform-agnostic, or device-independent, code assemblies containing metadata and intermediate language describing the source code as well as associated methods that provide gameplay and game features. Such assemblies can be utilized to compiled the game as needed for a specific device when a device is registered by a user via registration component 115. As an example, a game in game store 125 can be coded employing Microsoft® C#, compiled in a just-in-time (JIT) manner, and executed within CLR environment. It is noted that other high-level languages such as Microsoft® Visual Basic, Java™, Smalltalk, C++, Delphi, Perl, etc., can be employed as well. It is noted that execution can be carried out by code management component 135 or by virtualization component 155 (see below). It should be appreciated that metadata that describes an assembly in a CLR-based game source code can be employed to optimize a game's source code for a specific device, as well as for customization purposes and real-world embedding as discussed below. Such an optimization can adapt aspects of a game to fully exploit resources available in a device, thus enhancing a player's experience. Optimization can be conducted by optimization component 145, introducing metadata that manipulates a set of assemblies associated with a game's source code according to features provided by a device as well as characteristics of the game. Information related to a device for which a game is to be optimized can be collected by registration component 115 at the time player registers a device (see below). In addition, such information can be gathered through communication framework 190 from the device's manufacturer or from a similar device specification resource (not shown). In an aspect, game service 110 can establish a partnership with device manufacturers in order to have access to metadata and classes that can be used for optimization in specific devices.

Generally, optimization component 145 can employ artificial intelligence to conduct game source code manipulation automatically. The term “intelligence” refers to the ability to reason or draw conclusions about, e.g., infer, the current or future state of a system based on existing information about the system. Artificial intelligence (AI) can be utilized to identify a specific context or action, or generate a probability distribution of specific states of a system without human intervention. Artificial intelligence relies on applying advanced mathematical algorithms—e.g., decision trees, neural networks, regression analysis, cluster analysis, genetic algorithm, and reinforced learning—to a set of available data (information) on the system. In particular, optimization component 145 can utilize one of numerous methodologies for learning from data and then drawing inferences from the models so constructed, e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing the automated optimization described hereinbefore and related aspects.

As mentioned above, virtualization component 155 can execute a game that has been optimized for a specific device. It is noted that when playing a game, user-machine interaction takes place at a device, and such interaction typically can occur through a display and loudspeaker for visual and aural stimulation of a player's response, respectively, according to a game mechanics and through a controller that facilitates executing said mechanics. Communication framework 190 facilitates conveying traffic (e.g., game content) necessary for a player-machine interaction. Generally, when a device is registered with game service 110, virtualization component 155 establishes a virtual device (e.g., virtual device 2 165₂) that can be a software or firmware counterpart of the registered device registered in registration component 155. The latter maintains a record of the player that registered the device associated with the virtual device, and a game(s) that can be executed in the virtual device. It should be appreciated that virtual devices 165₁, 165₂, . . . , 165_{U} correspond to devices that can be registered by multiple users (U≦X+Y+ . . . +Z). The virtual devices 165₁-165_{U} can execute different games depending on the game registered by a user and his/her associated devices. In addition, two or more virtual devices (e.g., virtual device 165₂ and 165_{U}) can execute a real-time multiplayer game or a turn-based multiplayer game among disparate players, wherein the game can be competitive or collaborative. In an aspect, collaborative games within the connected gaming environment such as described herein, can be utilized to develop real-world skill (see below). In another aspect, a virtual device (e.g., virtual device 165₁) spans a time period corresponding to the duration of a gameplay instance. In yet another aspect, a virtual device (e.g., virtual device 165₁) can be persisted at a first time and removed at a second time according to a determination of the player that registered the device associated with the virtual devoice, or upon voiding the registration of a device associated with the virtual device.

Multiple virtual devices (e.g., 165₁, 165₂ and 165_{U}) execute a game synchronously even though streaming and/or broadcasting of game traffic can be directed to a single device in which the player-interaction takes place. Such synchronous multi-virtual-device execution is termed herein “replica gaming,” which in conjunction with communication framework 190 can support connected gaming experiences. It is to be appreciated that replica gaming can facilitate asynchronous gameplay. In an aspect, by executing the same instance of a game version that has been optimized for each of a set of registered devices, replica gaming ensures game state integrity during game play among disparate the registered devices. In another aspect, replica gaming can ensure optimal battery utilization for portable (un-tethered) devices that are part of a set of devices (e.g., 176₁-176_{Z}) a player (e.g., player N 170_{N}) has access to, as agent-machine interaction takes place upon demand rather than synchronously among registered devices. Additionally, replica gaming can provide with real time access in disparate devices to different stances of a game a player is playing. As an example, a player (e.g., player 2 170₂) in massively multi-player on-line game—in which case communication framework 190 can be a wide-area network, wire and/or wireless, that supports internet-protocol data packet communication—can participate in a gathering of elders to decide a war resolution concerning a threatening tribe through interaction with a first device (e.g., device 2 174₂), while unknowingly to other players, said participant can send a small group of elite warriors to kidnap a an enemy tribal leader in a second device (e.g., 174_{Y}).

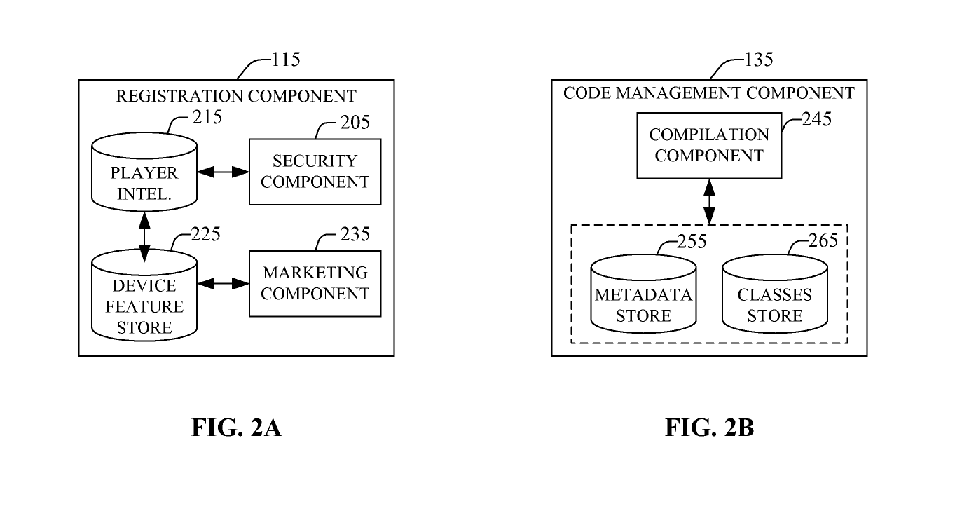

FIGS. 2A and 2B are block diagrams that illustrate, respectively, detailed example architectures of a registration component and a code management component. Regarding FIG. 2A, registration component 115 can include a security component 205 that registers a player and a set of his or her devices with game service 110, creating player accounts (not shown), and authenticates players 107₁-170_{N} and devices (e.g., 172₁-172_{Y}) that access the game service 110. Authentication proceeds via a communication framework 190 and can employ (i) an encrypted password or personal identification number, (ii) a voice signature which can be scrambled with a pseudonoise sequence at the time of analog-to-digital conversion for further protection of credentials, (iii) a sound sequence which can be pseudorandom and issued periodically or at specific time intervals, and so forth. Other forms of authentication are possible, but can increase device complexity such as iris and fingerprint recognition.

At the time of registering a player and associated devices, player “intelligence” is collected and stored in player intelligence store 215. In addition to intelligence in the context of AI mentioned above, player intelligence describes information that characterizes the player, his or her personal history or behavior, and records of commercial and non-commercial activities (providing reviews, for example) involving a product or service. Additionally, information on features that identify the devices registered by a player is collected and retained in a device feature store 225. Such information can be employed by a marketing component 235 in order to design and implement marketing campaigns of games targeted to specific segments of players—segmentation can take place according to demographic data, social stature, gaming history, and so on. Marketing component 235 can also employ player intelligence to determine a varied sample of individuals for testing various game development and design. Such testing can range from question-and-answer tests to sophisticated brain scanning of selected player segments, e.g., to measure effectiveness of challenge/reward structure within a game. In addition, marketing component 235 can handle licensing aspects of various games in game store 125, as well as assessing fees for game services, and so forth. Furthermore, marketing component 235 can pursue commercial partnerships with telecommunication businesses such as wireless communication providers and cable companies, independent groups of game designers and developers, network security and storage specialists, and the like.

With respect to FIG. 2B, code management 135 can include a compilation component 245 that can ensure game code source (not shown) of games stored in game store 125 is a platform-agnostic, component-oriented or object-oriented code, and can identify and store code classes in classes store 265 and metadata in metadata store 255 prior to compilation. In an aspect, compilation component 245 can be coupled to optimization component 135 to modify content in metadata store 255 and/or classes store 265 in order to compile game source code that is optimal for a specific device. Moreover, during development or design, changes to code metadata and classes that are necessary to achieve specific customization can be effected via compilation component 245.

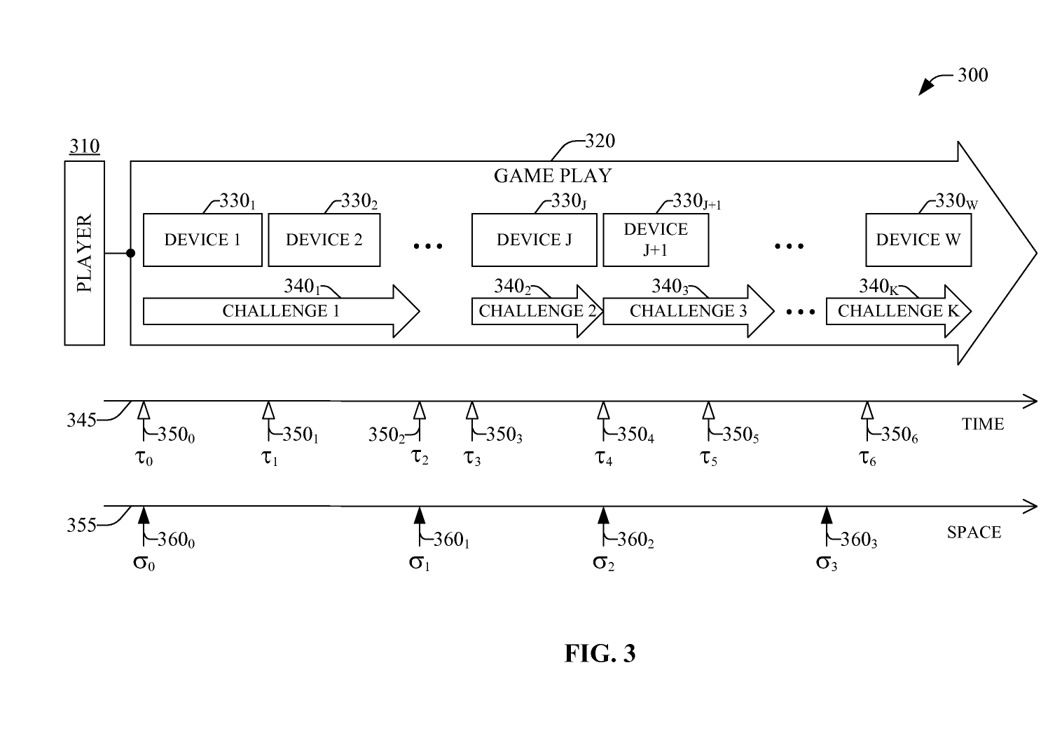

FIG. 3 illustrates a player's game play in which multiple challenges are played through connected gaming in multiple devices at disparate times and a plurality of locations in space. Player 310 can be substantially any of players 170₁-170_{N}, who utilize game service 110 to play a game, which can be one of a plurality of games stored in game store 125. Player 310 can employ devices 330₁-330_{W}, which the player has previously registered with game service 110 via registration component 115, to complete challenges 340₁-340_{K} associated with different stages of game play 320. Such challenges depend on the nature of the game, for example a challenge can be (1) to negotiate a technology transfer with another player, or acquire knowledge necessary to develop such a technology; to rescue an associate that has been kidnapped by an enemy faction; (2) to solve a series of text-based riddles; (3) to learn a new skill, or practice a newly acquired one through training sub-challenges (not shown) within a challenge—such skills can be applied to real world experiences or contexts as is in the case of learning a new language that is spoken by a disparate civilization or character—; (4) to scout an area and develop maps; (5) to build a character; and so forth. It should be appreciated that game play 320 can be disjointed, in that it can involve disparate challenges that are asynchronous, e.g., completion of challenge 2 340₂ is not necessary to engage in challenge 3 340₃. As an example, consider the case in which challenge 2 340₂ includes fighting a group of terrorists in a mountainous region, and challenge 3 340₃ comprises shooting practice with a variety of weapons in order to increase levels of weaponry knowledge, which can be employed when seizing an enemy's weapon. As another example, challenge 3 340₃ can include interviewing/questioning a prisoner. As yet another example, challenge 3 340₃ can entail drafting a peace agreement to be presented in discussion with leaders of an enemy group.

As illustrated in FIG. 3, challenges 340₁-340_{K} can be played in different devices, at different times (synchronously or asynchronously) and locations. In an aspect, challenge 1 340₁ is played in device 1 330₁ and device 330₂, wherein switching devices takes place at time τ₁ 350₁. Switching devices during a challenge, e.g., challenge 1, is facilitated by the replica gaming paradigm described hereinbefore, wherein game 320 is executed by devices 330₁-330_{W} synchronously. In another aspect, it is noted that at time τ₂ challenge 1 340₁ ceases to be played, e.g., player 310 has arrived to his or her workplace (location σ₁), and player 310 resumes game play 320 by engaging in challenge 2 340₂ at time τ₃—it is noted that at the latter time player 310 still is on location σ₁. Player 310 switches from device J 330_{J} to device J+1 330_{J+1} at time 4 and initiates challenge 3 340₃, a change that can be associated with switching to location σ₂ (for example, player 310 is returning home from work). At time τ₅, player 310 continues challenge 3 340₃ but switches to another device (not shown) while in the same location (e.g., σ₂). Device W 330_{W} is employed to continue challenge K 340_{K} at time τ₆; note that such challenge is initiated upon switching to location σ₃. As discussed above, in a challenge, devices can overlap in time and space such as in the case that disparate stances of a game are accessed by player 310 during the challenge. In addition, it should be appreciated that a user can switch back to a previously used device during game play 320.

It should be appreciated that device changes during time line 345 and space line 355 are afforded by the connectivity of the gaming experience which, in an aspect, is largely based on replica gaming substantiated by game service 110 primarily through virtualization component 155 and communication framework 190. It should further be appreciated that transition among devices during a challenge is seamless, limited by latency aspects of a communication channel (not shown) associated with communication framework 190—it is noted that latency for data traffic in LTE wireless communication can be of the order of milliseconds.

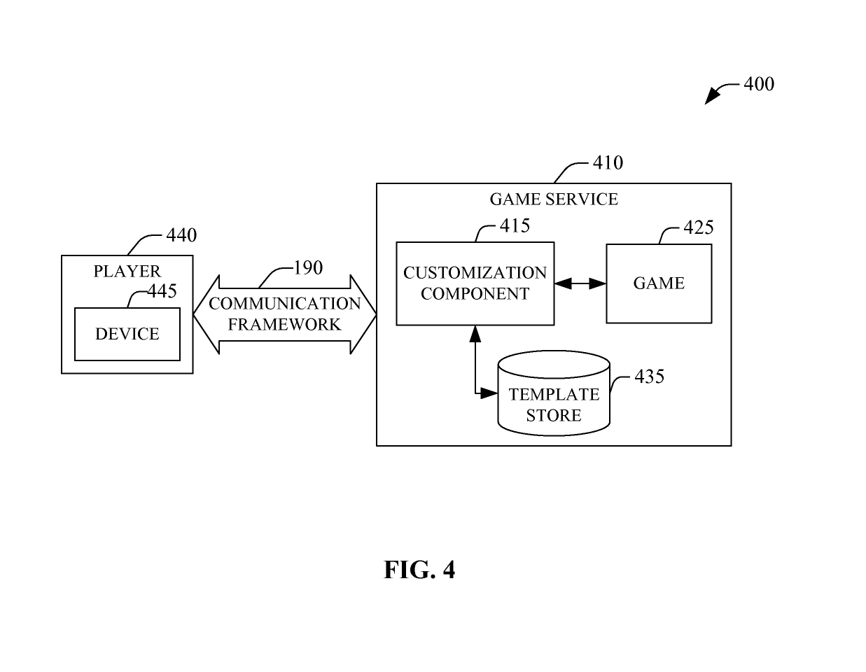

FIG. 4 is a block diagram of an example system 400 that facilitates customization of a game for a player's device. Game service 410 provides player 440 with a customization component 415 to modify game 425. Customization exploits a template store 435 which can be developed by game service 410 through community efforts (see below) or marketing efforts and can allow player 440 to introduce features in game 425 to play in device 445. Additionally, templates in template store 435 can be device specific, based on information available on devices registered with game service 410. Communication among game service 410 and player 440 is accomplished through communication framework 190. Game service 410 substantially operates as described in connection with game service 110 through substantially the same components.

Customization proceeds at a player request and it can allow development of features for game characters, vehicles, and buildings, game soundtrack and so on. Moreover, customization can be effected in real time during gameplay. Customization component 415 can offer development tools through a user interface accessible from device 445. Such tools can rely on template store to provide player 440 with pre-developed features for game 425; e.g., a set of weapons, a line of clothing for game characters; music/sound fragments for specific instances like upon successful completion of a challenge or during specific challenges such as an enemy chase in a fighter jet; specific behavior for a character such as celebratory dances upon a character scoring a touch down in a football game or scoring a goal in a soccer game; specific greetings or behavior prior to battle with an enemy or upon prevailing in the battle; space features such as rivers, mountains, ruins, housing, bushes, and forests; etc. Such features can be further developed by player 440 through customization tools; for example a greeting employed by a character prior to a fight selected from template store 435 can be modified to reflect a specific language accent or dialect of choice for player 440. Upon a customization step, consistency of the modification can be evaluated by customization component 415 and suggestions for feature development can be offered to player 440.

To effect customization into a game, customization component 415 can employ metadata to modify classes in a game (e.g., game 425) source code. Such modification can be transparent to player 440, and provided through a user interface (UI) similar to development and designer Uis typically found in application development tools. As mentioned above, consistency checks after a customization can be performed via the UI and can include establishing adequate class dependencies throughout the game's code. In an aspect, a UI in customization component 415 can be a lightweight version of Uis available in Microsoft® Visual Studio.

In view of the substantial connectivity among player provided by game service 410, customization component 415 can present player 440 with indications of similarly developed features by other players (not shown); thus, player 440 can adopt disparate features from such other players or can adhere to the common features. Moreover, customization component 415 can provide player 440 with an update tool that alerts player 440 of customization performed by another player, to allow player 440 to respond to such customization. It is noted that such an update can be conveyed to a player in real time, or at predetermined time intervals. A response from player 440 can be particularly warranted, for example, in an MMOG in order to emphasize player differentiation or to mitigate disadvantages that can stem from other player's feature changes—e.g., if a player customizes an elite sniper with an invisibility cloak, player 440 can develop a light source for which said invisibility cloak is rendered dysfunctional, and add such light source to his weapons and night vision equipment.

Access to customization component 415 and customization features available from template store 435 are managed by game service 410, via a registration component (such as registration component 115), and can be accessed by player 440 through a premium license, for example, to game 425 or on a pay-per-feature basis. A game service (e.g., 110 or 410) can employ customization described herein as an instrument to mitigate player attrition, and promote game penetration in the market; for example, providing access to customization features on a promotional basis. Such promotional aspects can be managed by a marketing component, e.g., marketing component 235.

In an aspect, a customization component 415 can be coupled to an optimization component (e.g., optimization component 145) to ensure that aspects of the game are consistent and provide adequate game mechanics and gameplay—for example, the physics involved in utilization of a weapon, wherein a weapon can cause a character to have a center of gravity located too high and can compromise equilibrium during battles, the biomechanics of fighting is adequate, for example a fight maneuver can be such that it can take a long time to execute and can expose integrity of the character executing the maneuver during combat, or the engineering aspects of vehicles, such as in the case a speed afforded to a racing car can be so high so as to compromise car stability.

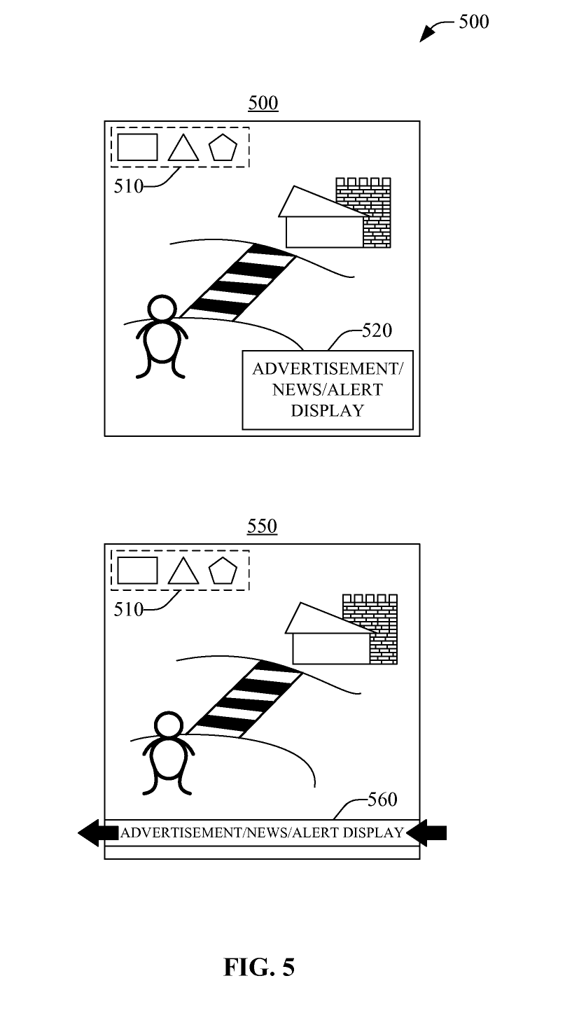

FIG. 5 illustrates example displays of advertisement, news, or information in a game display in a device employed for gameplay and agent-machine interaction. In view of the connectivity provided by a game service (e.g., game service 110 or 410) through communication framework 190, such content can enhance the connected gaming experience and can assist on game play and real-world activities. Panel 500 illustrates a display presenting a display 510 that provides information directly related to a game challenge—in the illustration a character prepares to jump across a cliff—information displayed in 510 can be symbolic, illustratively represented in 510 with a rectangle, a triangle, and a pentagon, and can indicate level of character's health or vitality, level of ammunition available, special abilities such as spells or invisibility instances remaining, positioning information, fraction of a level yet to be completed and so on. An advertisement/news/alert display 520 can provide a player with information related to gameplay or with information related to the player's real world environment. Display 520 can be rendered during a finite period of time and it can be toggled on and off by the player.

Advertisement. A game service (e.g., game service 110) can advertise future releases of a game being played, or it can also deliver promotional announcements, such as customization capabilities available for a game and conditions to access such capabilities, or it can promote specific music bands by introducing the band songs or instrumental pieces into a game and announce/indicate said song or pieces in the advertisement display when employing them in specific challenges or levels in a game. In an aspect, a game service can partner with record studios to promote specific artists, selected based at least in part on player intelligence (collected during registration or otherwise) and game premise or mission statements; for instance, a bull riding simulator can include fast-paced country music, whereas a fighter game can be better suited for hard-core rock-and-roll sounds, or a brain training game can utilize various allegro or molto allegro movements of classical music pieces. A marketing component 235 and an optimization component 145 can be employed to scout, through communication framework 190, music and artists that can warrant commercial partnerships, and to match music pieces with games or game challenges, to elicit desired reactions and promote player engagement and entertainment.

Additionally, a game service can target its advertising campaigns based on player intelligence (FIG. 2) collected at the time a player registers a game and devices; in particular, advertisement presented in display 520 for a game can be different depending on the player that is playing the game, even when the game is an MMOG wherein disparate players participate.

News. A game service can broadcast news related to a game being played. Such news can keep a player abreast of developments in other geographic areas of a game, a feature that can influence gameplay of a player receiving the news, e.g., a terrorist attack has taken place in a foreign country, such event can influence a player to suspend a trade summit with leaders from the country in which the terrorist attack took place; or a ship carrying food supplies and currencies for a colony has been boarded by pirates; or yet a newscast can present result of soccer matches in a foreign soccer league, or golf handicap rating updates in a golf game. It should be appreciated that news can be associated with a plurality of games that a user has registered with a registration component (e.g., component 115) in the game service. The news can prompt a player to employ a disparate device to that he or she is utilizing to play to follow up developments in a disparate game; for instance, a user can turn on flat panel display to follow up the developments of a the disparate games, while continue playing a first game in a console connected to a second display (the display in which he is receiving the news).

Alerts. Game service can deliver alerts related to activities of other players connected to the game service. An alert can also be a scheduled event in a calendar application running in the device employed to play a game, or in view of the connectivity of the gaming experience, an alert can be received from a disparate device that the player has registered with the game service; e.g., an email application running in a computer at the player's workplace can alert the user of newly received email in the device the player is employing to play. As an example, Microsoft® Outlook can render a new email alert in a player's television set connected to an Xbox console in which World of Warcraft is being played. In another example, a second player or other non-player user can send an instant message via Windows Live Messenger from a desktop computer to a first player that is engaged in gameplay. The first player can respond to the IM through the device employed for gaming, or through a second device. Alerts can also relate to events associated with other players of games that a player has registered. Such alerts can indicate, for example, customization features recently acquired by one of said other players (see above; FIG. 4).

Display 550 presents an alternative, or additional, embodiment for advertisement/news/alert display 560. In the embodiment, content is scrolled from side-to-side in the bottom part of a display in a device employed by a user to play a game.

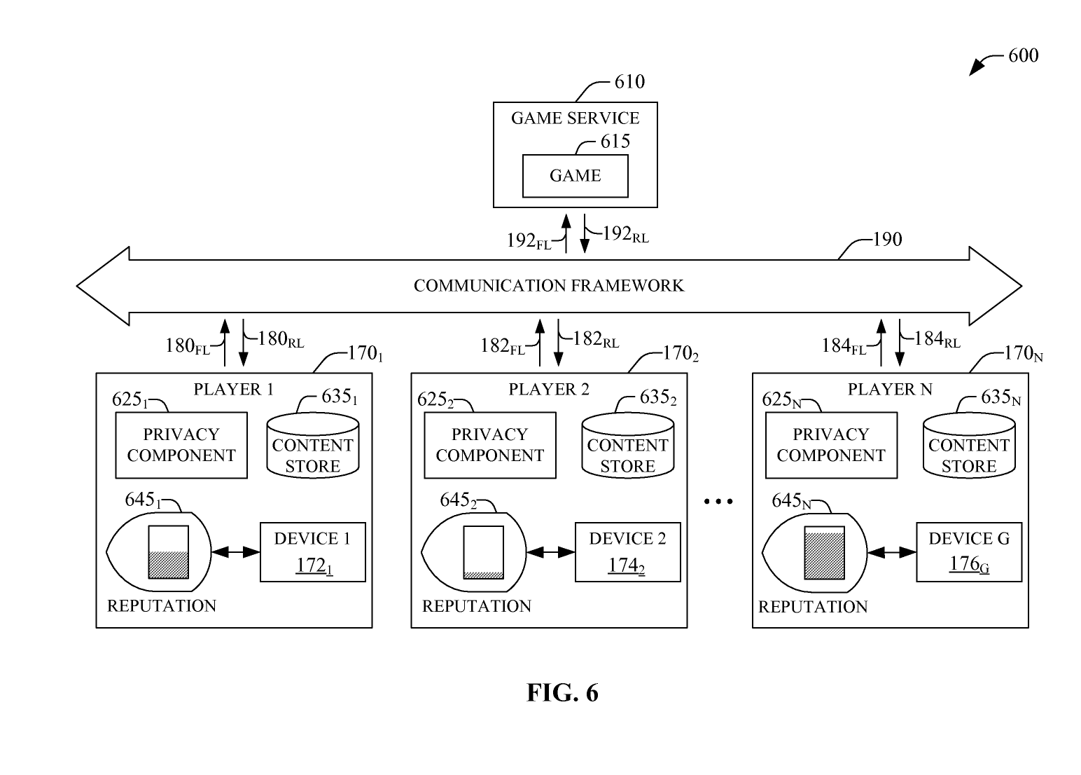

FIG. 6 is a block diagram of an example system 600 that facilitates disclosing game related information among users in a connected gaming environment. Game service 610 hosts a game 615 that is played by players 170₁-170_{N} through a communication framework 190. Players can utilize disparate devices, e.g., player 170₁ employs device 172₁, player 170₂ utilizes device 174₂, and player 170_{N} employs 176_{G} which can be disparate. Communication framework 190 allows a player (e.g., player 170₂) to convey information to other players. Each player can employ a privacy component (e.g., 625₁-625_{N}) to determine the player's content that is made public and the content that is kept private, wherein concealing and providing content is based at least in part on a recipient's identity. Additionally, a privacy component can also provide a player with publishing tools that allow the player to edit music, photos, produce webpages which can include blogs, etc. Said content can be stored in a content store (e.g., 625₁-625_{N}) associated with each player, which can be managed and retained within game service 610. Security of both public and private player's content can be provided by game service 610, through a security component (not shown). A player's content can include tutorials on specific challenges of a game, or instructions to overcome specific challenges within a level in a game (e.g., game 615), it can also contain opinion on aspects of a game (e.g., game 615). In addition, the content can include news clips associated with event that have occurred in a game (see above; FIG. 5), and it can also include music, videos, and photographs produced by a player (e.g., 170_{N}).

In an aspect, the tutorials and instructions that a player posts or conveys to other players can be peer-reviewed and such review can be conveyed to the game service that hosts the game for which the material is intended. Such reviews can lead to peer-based reputation ratings (e.g., reputation 645₁-645_{N}), or popularity ratings, that can be displayed with the content a player makes available. As an example, as illustrated in FIG. 6, reputation can be indicated with a status bar indicating the reputation rating (or popularity rating) of a player—e.g., player 170_{N} appears to be highly reputable player, whereas player 2 170₂ has low reputation and player 1 170₁ exhibits what can be considered an average reputation. Quantification of “reputation” can be based on a score algorithm implemented by a game service (e.g., game service 610) that employs evaluation pointers such as nature of content published, reviews of peers, and so on.

It should be appreciated that devices employed by players to convey content to other players can be disparate. For example, player 170₁ can send a short service message (SMS) to player 170_{N}, which can receive the message in a console controller and render that message in a suitable display. Moreover, depending on the device that player 170₁ is utilizing, the SMS message from player 170₁ can be converted to an audio message and conveyed to player 170_{N} in such a format. Generally, conversion of such messages can be effected by a game service through communication framework 190; for instance, a data package representing content transmitted by a player using a desktop computer can be converted to analog signals and transmitted via an air-interface that services a wireless device that a second player is utilizing to communicate and receive content. Conversion can take place at said base station, upon receiving the data package via backhaul communication from an originating port in a packet-switched network. It should be appreciated that other conversion types are possible, and multiple network technologies can be employed to communicate messages among players employing disparate devices.

It should be appreciated that game service 610 operates in substantially the same manner and with substantially the same components as game service 110.

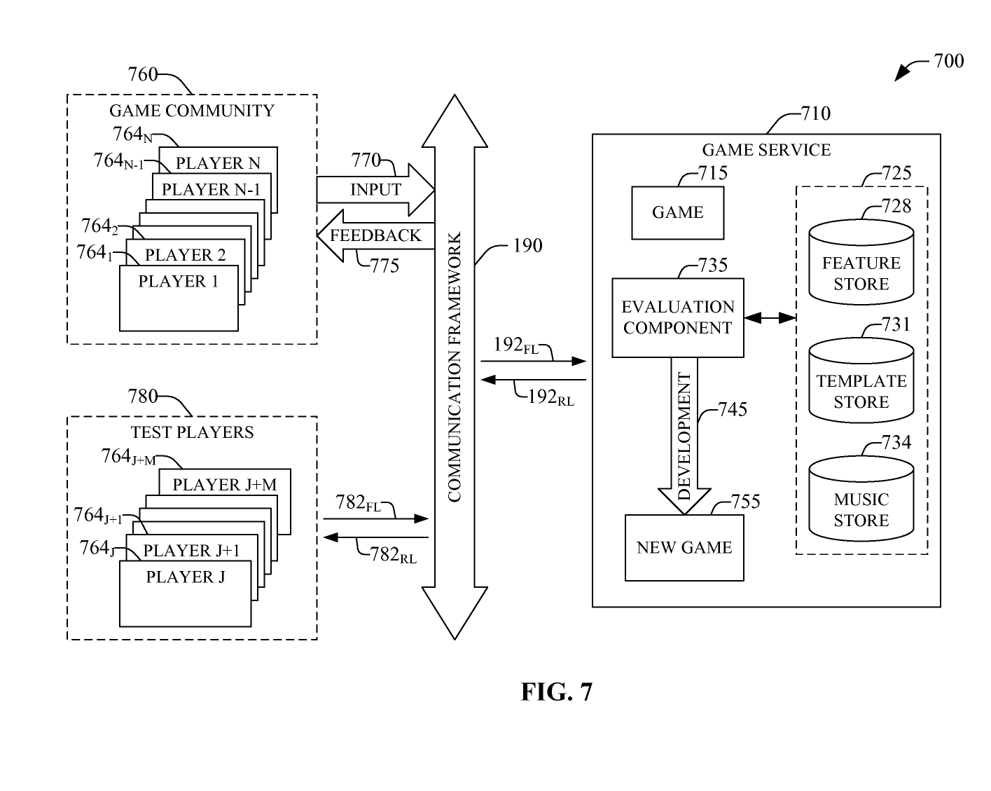

FIG. 7 illustrates a block diagram of an example system 700 for community development of a game in a connected gaming environment. Connectivity among players afforded by a connected gaming experience as described herein can result in formation of communities associated with games provided by a game service (e.g., game service 710). Such communities can drive the development of a game, wherein the game service can behave as a moderator and can implement the actual development of the game. Accordingly, game 715 provided by game service 710 can be developed by its associated community 760. To facilitate the game community 760 efforts, game service 710 can provide resources 725 for developing game 715, such resources can include a feature store 728, a template store 731 and a music store 734. In a component-oriented design, feature and template stores contain classes and metadata that are re-usable and can be employed when the game community 760 develops code for game 715. It should be appreciated that resources 725 need not be strictly employed by the game community 760. An evaluation component 735 evaluates the development proposed by the game community 760, and can establish organizational procedures for development, such as maintaining a source code repository and preparing code documentation for the development. Evaluation performed by evaluation component 735 can restrict to identifying bugs and ensuring the design does not presents faults, e.g., proposed development lacks failure states. Moreover, evaluation component 735 can ensure game developments are consistent with platform-agnostic coding such as CLR. Furthermore, feedback associated with game development can be tracked, in real time for example, by evaluation component 735. To maintain and foster a sense of identity in the community, game service can allow the community to steer a game's premise and mechanics to the extent there is community agreement. It should be appreciated the providing the game community with such autonomy can result in a commercial advantage for the game service 710, which can target marketing campaigns for products associated to a highly customized game to the segment of players (e.g., 764₁-764_{N}) that are part of the game community. Marketing campaigns can be conveyed through platform-agnostic advertisement displays associated with a game (e.g., displays 520 or 560).

Generally, when a game community 760 develops a game, players 764₁-764_{N} propose developments which are conveyed as input 770 to a group of test players 780, which includes a subset of the game community players, e.g., 764_{J}-764_{J+M}. Communication is effected through communication framework 190 via RL 782_{RL}. Test players 780 conduct tests on a game version with proposed developments and returns feedback 775 to the game community 760. After an iterative process, which can involve identifying in on a competitive basis, e.g., through development contests or bids for development, evaluated by test players 764₁-764_{N} or the game community 760, the development among the community-created content that is to be committed to game 715, community 760 conveys the content to game service 710. In an aspect, development contests can aim at level design, character design, soundtrack composition, etc. Such content is evaluated by evaluation component 735, post-processed and evaluated for consistency, and committed into a developed 745 new game 755.

It is noted that each player in game community 760 has registered a set of devices (not shown) devices with game service 710, and each player can suggest game developments (e.g., input 770) according to said registered devices. Yet, development input can be conducted in a platform agnostic manner through component-oriented source code contributions that can be compiled and executed for a specific device as discussed above in connection with FIG. 1.

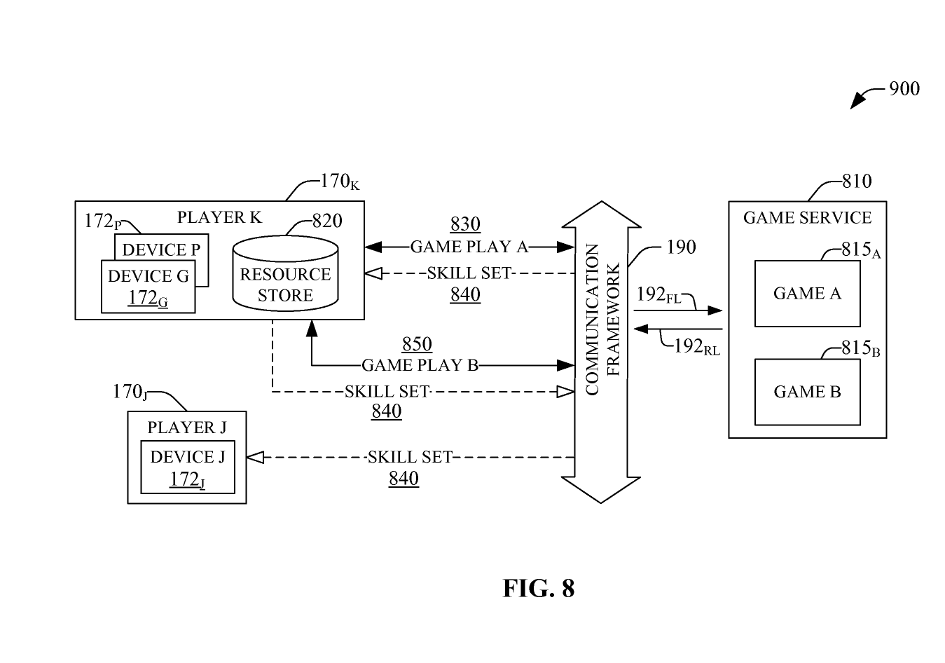

FIG. 8 illustrates an example system 800 that facilitates transferring skills developed by a first player through gameplay in a first game to gameplay in a second game and to a second player. A player 170_{K}, with registered devices 172_{G} and 172_{P} in game service 810, plays a game A 815_{A} in device 172_{G}, such a game can be a stand alone game or an MMOG, and through gameplay A 830 the player 170_{K} develops a skill set 840, e.g., solves a set of riddles that open a secret passage, learns a dialect spoken by the enemy by solving puzzles, learns to operate heavy machinery that can be employed to attack an enemy, learn specific wrestling and fighting moves, or the like. Such skill set 840 can comprise learning specific key combinations in a game controller in a device, or specific sequences of jumping and punching, as well as memorizing maps, or certain word combinations that can be uttered by a character in game A 815_{A} to resolve specific challenges during gameplay 830. Player 170_{K} can store the skill set 840 in a resource store 820, which can also contain other resources to play game A 815_{A} such as maps for completed missions, manuals of operation of specific weapons, files containing answers to specific riddles, or files containing movement sequences and sequences of key strokes that facilitate resolving a specific challenge.

While connected to game service 810, player K 170_{K} can initiate or resume a game B 815_{B}, which can comprise challenges that are related to those of game A, for example a character in game B 815_{B} is expected to jump through a series of mobile blocks and reach a treasure that increases the character's wisdom or heals the character's wisdom, while in game A 815_{A} a character is expected to fight an enemy character while standing on a moving platform; so player K 170_{K} can employ his or her timing skills for jumping and punching in game A 815 to jump through the obstacles in game B 815_{B}. Another example can be a challenge in game B 815B that includes shooting moving targets with a variety of weapons, in this case player 170K can employ shooting and timing skills developed through game play 830, and stored in resource store 820, to traverse the challenge. In yet another example, player 170K can face a brain challenge in a dialect that shares similarities with a dialect the player has mastered in game A 815_{A}. It should be appreciated that player 170_{K} can switch to a disparate device 172_{P} when switching from game A 815_{A} to game B 815_{B}. It should be appreciated that game A 815_{A} and game B 815_{B} can also be disparate gaming contexts of a same game.

Additionally, a skill set 840 stored in resource store 820 can be transferred to a disparate player J 170_{J}. Conveying contents of resource store 820 can be accomplished through communication framework 190. In one aspect the transference of skills can take place in real time as a game (e.g., game A 815_{A} or game 815_{B}) is played. In such a gameplay mode player 170_{J} can play the game in device J 172_{J} and player 170_{K} can be streamed player J's gameplay to his or her device 172_{G}. Then, utilizing communication framework 190, player 170_{J} can convey the skill set. The latter can be accomplished with an instant messaging device, through audio communication (e.g., voice over internet protocol (VOIP)), or by temporarily conferring the control of player 170_{J}'s game play to player 170_{K}.

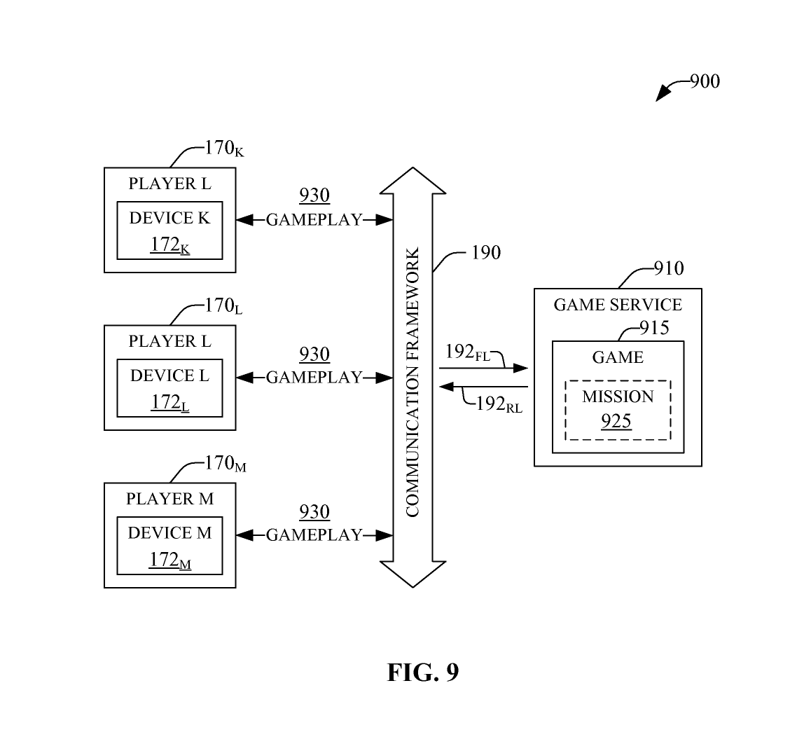

FIG. 9 illustrates a block diagram of an example system 900 for a collaborative play group that exploits a connected gaming environment and aims at building players' real world skills. Game service 910 hosts a collaborative game 915 in which a game challenge consists of an open-ended mission 925 that is undertaken by a set of three players 170_{K}, 170_{L}, and 170_{M}, employing disparate devices 172_{K}, 172_{L}, and 172_{M}. Communication framework 190 and FL 192_{FL} and RL 192_{RL} facilitate communication among players and game service, and game service 915 allows players to participate in the same game instance (e.g., synchronously), which typically is a necessary condition in a collaborative game, employing disparate devices (e.g., 172_{K}, 172_{L}, and 172_{M}) through replica gaming. Failure states in game 915 can be associated with a failed mission due to lack of skill development rather than, for example, with one of the player's character demise. Game 915 generally is a simulation game (e.g., The Sims) wherein specific skills are developed through gameplay 930, which is correlated among players. In an aspect, game 915 can focus on developing social skills. Such a game can be employed by service businesses to improve customer-employee interaction, by law enforcement officers to develop specific sensitivity towards specific demographic groups, by therapists to provide children that have suffered abuse develop a trusting relationship with an adult (both embodied in a pair of players, e.g., 170_{K} and 170_{L}). It should be appreciated that other games can be facilitated by game service 910 focusing in skills other than social skills; for instance, a second language, personnel management, finance management, and so forth. In another aspect, game service 910 can modify game 915 dynamically (e.g., in real time) in order to challenge certain aspects of the player's skill development.

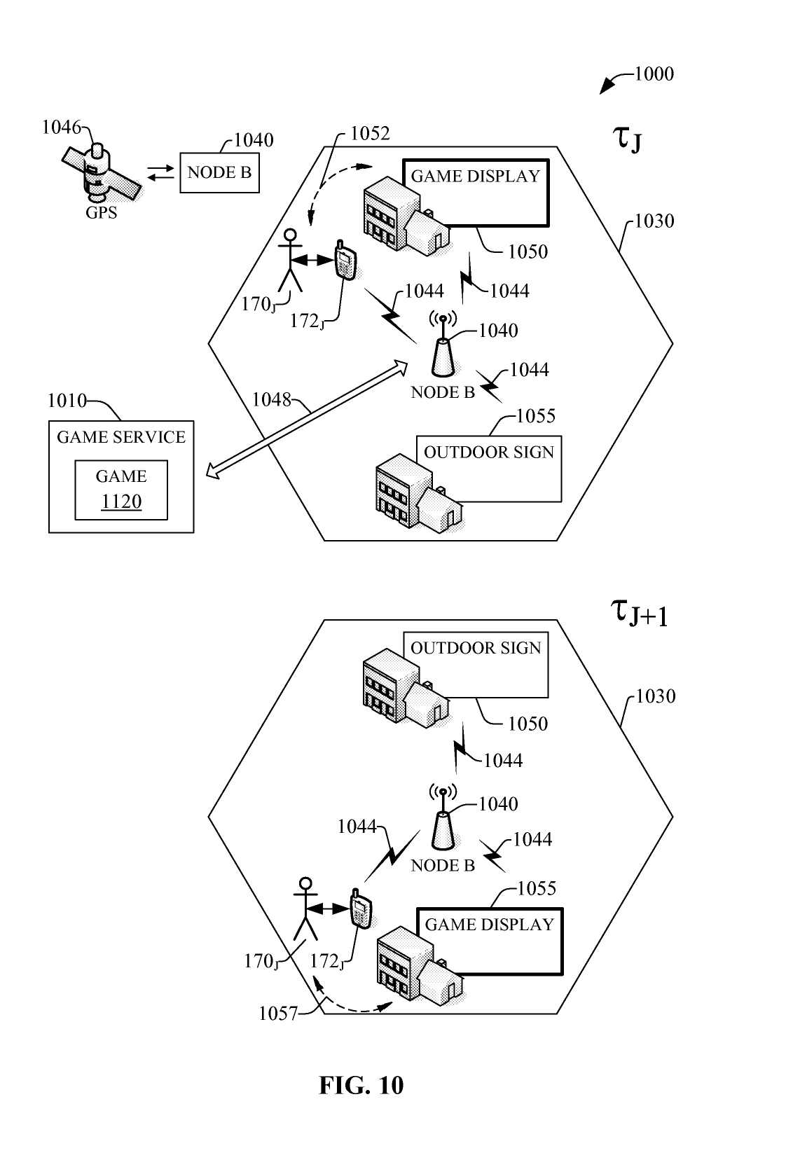

FIG. 10 illustrates an example system 1000 in which a game is embedded in the real world (e.g., real world embedding; it should be appreciated that real world embedding can also account for, or indicate, embedding of real world features into a game). Game service 110 hosts a game 1020 that can be played by one or more players (e.g., 170_{J}), who can utilize disparate devices (e.g., device 172_{J}) as discussed in connection with FIG. 1. A portion of real world is represented in a hexagonal cell 1030 which in one aspect coincides with a wireless sector serviced by a base station (also termed Node B) 1040. A player (e.g., player 170_{J}) can communicates with Node B 1040 through an air-interface channel 1044, and communication among Node B 1040 and game service 1010 can take place through a backhaul communication loop 1048 in the wireless provider network (such provider can be a commercial partner of the game service provider). It should be appreciated that wireless link 1044, base station 1040, and backhaul communication loop 1048 are part of a communication framework 190 (not shown in FIG. 10) utilized by game service 1010 for a connected gaming experience. It should further be appreciated that other players engaged in gaming through game service 110 can connect to, or communicate with, player 170_{J}. To accomplish embedding of game 110 in the real world, a global positioning system (GPS) 1046 can communicate with base station 1040 and thus attain connectivity with game service 1010 and its associated players. It should be appreciated that GPS 1046 can be combined with a relaying wireless local area network in order to track indoor real-world locations. Moreover, it should be further appreciated that substantially any location system can be employed instead of a global positioning system providing with the same advantages described supra.

In an aspect, real world embedding can employ fixed city outdoor signs typically available in a city or mobile signs, e.g., panels employed during road construction for advising drivers on road conditions. Such outdoor signs can operate conventionally as an outdoor announcing/advertising service (1055) or as a game display (1050) to facilitate real world embedding. Outdoor signs can communicate wirelessly with Node B 1040 through a wireless link 1044. (It is noted that game service 1010 can develop a commercial partnership with outdoor sign businesses to deploy real-world embedded displays.) By utilizing GPS 1046, game service can determine the position of a player (e.g., 170_{J}) of game 1020 and toggle an outdoor sign in proximity to the player to game display; for instance at an instant τ_{J}, player 170_{J} is in proximity (indicated with arrow 1057) of outdoor sign 1050, which is switched to game display, whereas at an instant τ_{J}+1 at which player 170_{J} has reached another position in the real world, outdoor sign 1055 can be actuated to display a game as it is this sign that one that is in proximity (arrow 1057) to the player

Real world embedding can be passive or active. In passive embedding, real world signage (1050 and 1055) render game display according to a game 1020's level/challenge space, e.g., street alley or neighborhood according to a fighter game. In another example, game display can consist of clues or information associated with game play consistent with game 1020. It is noted that such information can be complementary to the game instance displayed in a device (e.g., 172_{J}) that a player uses to play. In active embedding, game 1020 adopts elements of the real world into its game audiovisual display, while preserving the game mechanics. In such a case, a player's device can be primarily utilized to control gameplay. As an example, camera system attached to an outdoor sign and its neighborhood (e.g., traffic lights, shops, public buildings, banks) captures space context, which depends on sign/player location, and conveys such context to game service via Node B through backhaul communication loop 1048, the context is processed at game service 1010, e.g., by a virtualization component (not shown), and game 1020 is modified to incorporate the real world context. The player (e.g., 170J) can thus play game 1020 within the real world in his/her environment. As an example, game 1020 can be a street fighter game, wherein fights can take place on the player's path to his or her workplace. It should be appreciated that more than one player, utilizing disparate devices, can exploit real-world active embedding, as the embedding is dictated primarily by player positioning within the real world with respect to signage equipment. Active real-world embedding can be an instrument for training for the military, law enforcement personnel.

Generally, real world embedding can be employed as a medium for a game marketing campaign. Additionally, as discussed above in connection with FIG. 5, real-world embedded displays can render player/game specific content such as alerts, news, and advertising. Thus, real world embedding can be offered as an advertising medium for players.

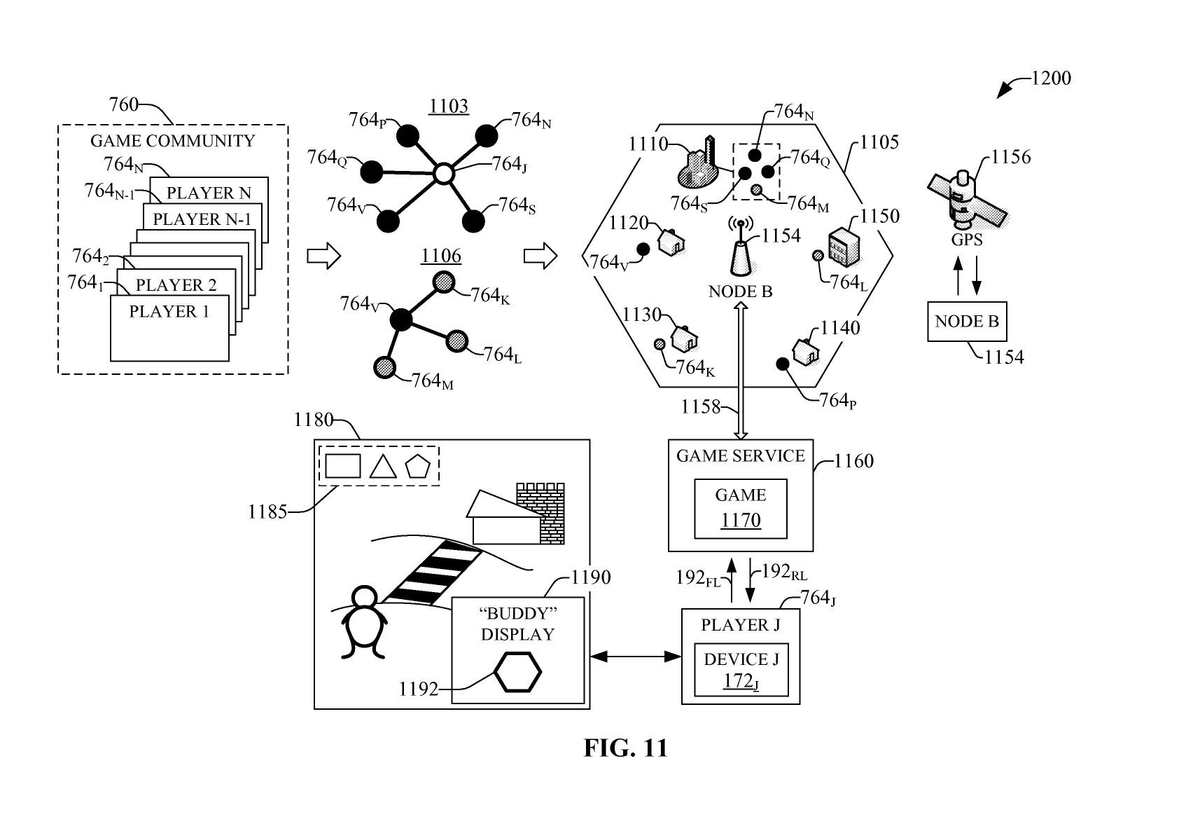

FIG. 11 illustrates an example system 1100 that facilitates access to real world position of specific player(s) within a game community. A game community 760 that includes players 764₁-764_{N} can be classified as a network, wherein each player is represented as a node. For a specific player, e.g., 764J, diagram 1103 is a first-layer (e.g., a friend) fragment of a network diagram associated with game community 760. In such diagram the length of links connecting to players 764_{V}, 764_{Q}, 764_{P}, 764_{N}, 764_{S} indicate the level of affinity, or similarity, among the connected players. Diagram 1106 illustrates a second-layer (e.g., a friend of a friend) fragment diagram for player 764_{J}, and a first-layer fragment for player 764_{V}. Each node in a network diagram can be described by metadata containing player intelligence, such metadata can be utilized, for example, to customize aspects of a game (e.g., game 1170) such as music and sound effects. In addition, through connectivity afforded by a game service (e.g., game service 1160), each node can be located in the real world, illustrated with a wireless service cell 1105. In an aspect, as discussed above in connection with FIG. 10, connectivity can be provided by a wireless Node B 1154 covering cell 1105 and connected to game service 1160 through a backhaul communication link 1158. Real world positioning information can be delivered by a GPS 1156 that can communicate with Node B 1154. It should be appreciated that GPS 1156 can be combined with a relaying wireless local area network in order to track indoor real-world locations. Moreover, it should be further appreciated that substantially any location system can be employed instead of a global positioning system providing with the same advantages described supra.

In an aspect, each player associated with first- and second-layer fragments 1103 and 1106 can be located within cell 1105, and their location conveyed to player 764_{J} who can be engaged in gaming through device J 172_{J}. As an example, the locations conveyed can include the following. Players 764_{N}, 764_{S}, 764_{Q}, and 764_{M} are together in a location in an establishment in a downtown 1110 area, while player 754_{V} is at his/her house 1120, player 764_{K} is at his/her house 1130, player 764_{P} is at home 1140, and player 764_{L} is in his/her workplace 1150. As illustrated in FIG. 11, location information is accompanied with an indicator (color, for example) that determines which fragment a located player belongs to. Such information can be displayed in a “buddy” display 1190, rendered with suitable indicia 1192, within a display 1180 in device 172_{J} that player 764_{J} is utilizing to play game 1170. A “buddy” display can be accessed from an information bar 1185 associated with game 1170 (see above). It should be appreciated that in view of the replica gaming that can be implemented by game service 1160, “buddy” display 1190 can be rendered in a disparate device registered by player 764_{J}. As an example, player 764_{J} can play in a cell phone while a “buddy” display is conveyed in the player's smart glasses (not shown), which can render images through a thin-film transparent display with associated processing capabilities. Said glasses can receive signal from the player's personal network based on a Bluetooth device.

Additionally, a “buddy” display can provide a player with functionalities that allow communication with located players in the real world. Such functionalities can be displayed in a game information bar (e.g., 1185) and can include an instant messenger, for example Microsoft® Windows Live Messenger or the like, or email capabilities, and can be provided via remoting to and from a device that runs the actual application that provides said functionality. Remoting can be implemented via a game service's communication framework.

The connectivity provided by game service 1160 through its communication framework (indicated by forward link 192_{FL} and reverse 192_{RL}; see also FIG. 1) can be generally exploited to connect with trusted people—herein termed “associates”—outside game community 760. For example, associates can be family members, workplace colleagues, gym acquaintances, bible-study group members, salsa class peers, chess club member, music or movie star fan-club members, and so forth. Positioning information on each of these can be displayed in a “buddy” list display 1190. Members in the example groups illustrated above can overlap in disparate groups; such overlap can lead to dependencies among the groups. A game service can offer a network classification, analogous to network diagrams 1103 and 1106, and classify those diagrams through metadata and classes. Such classification can facilitate delivery of position information, e.g., with a player selecting specific Mth-layer fragments (see above) in a network diagram to be displayed in a “buddy” display such as display 1190; selection of a specific layer fragment to be determined can be effected through a game information bar displayed in a device employed for playing a game. In addition, a classification can be used for tagging on-line content, which can be reached through game service's communication framework, wherein the tagging can indicate which content/resource has been used by associates, thus conferring to such content/resource varying degrees of “trust.” For example, a skateboard store accessed and engaged in a transaction by one of a player's skateboard associates renders such store trustworthy. It should be appreciated that associate classification and utilization of such classification is facilitated by the rich connectivity afforded by a connected gaming service.

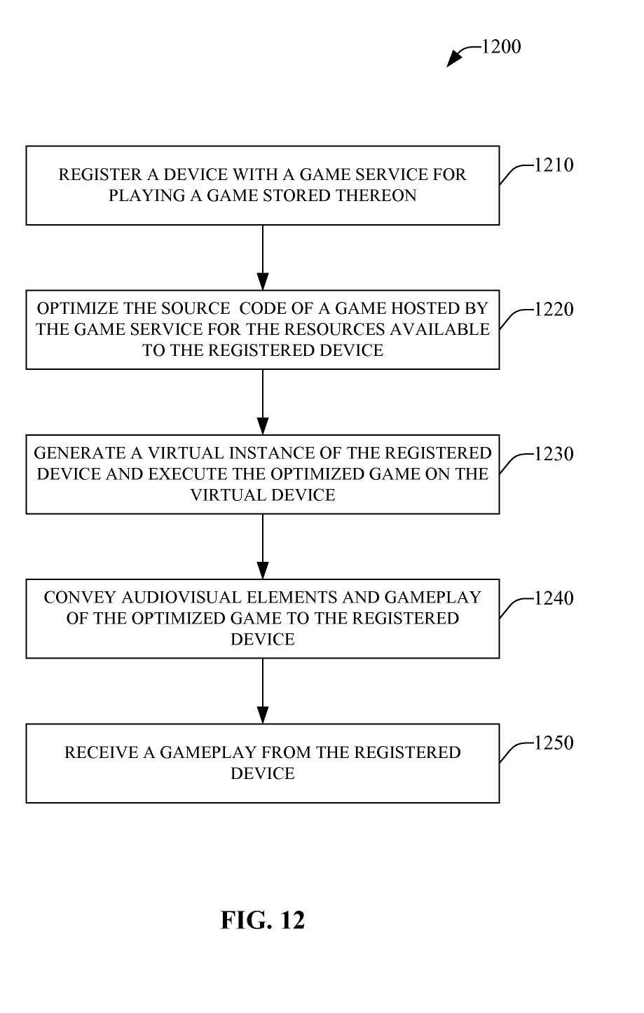

In view of the example systems presented and described above, methodologies that may be implemented in accordance with the disclosed subject matter, will be better appreciated with reference to the flowcharts of FIGS. 12-17. While, for purposes of simplicity of explanation, the methodologies are shown and described as a series of blocks, it is to be understood and appreciated that the disclosed aspects are not limited by the number or order of acts, as some acts may occur in different orders and/or concurrently with other blocks from what is depicted and described herein. Moreover, not all illustrated acts may be required to implement the methodologies described hereinafter. It is to be appreciated that the functionality associated with the blocks may be implemented by software, hardware, a combination thereof or any other suitable means (e.g., device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 12 presents a flowchart of an example method 1200 for a playing a game within a connected gaming environment. At act 1210 a device is registered in a remote game service (e.g., game service 110) for playing a game stored thereon. Game service can provide for a connected gaming experience by connecting multiple players and devices, each of which is registered with the game service. Connectivity can be facilitated by a communication framework (FIG. 1) available to the game service, the communication framework can include wired and wireless networks. At act 1220, the source code of the game hosted by the game service is optimized for the resources available to the registered device. Such resources can form at least in part the player experience while playing the game, and can include aspect of the device such as processing memory, computing speed, real state for displaying content, graphics resolution, sound outlets, and so forth. In an aspect, the optimization can be conducted automatically, by using artificial intelligence (see FIG. 1) which can employ as a portion of its optimization input a set of device features and player intelligence made available to the game service at the time of registering a device. At act 1230, a virtual instance of the registered device is generated and the optimized game is executed in the game service, e.g. in a virtualization component such as component 135. At act 1240, audiovisual elements of the optimized game and gameplay are conveyed to the registered device. In an aspect, the game executed in the virtual device is streamed to the registered device through the communication framework available to the game service. At act 1250, gameplay is received from the registered device.

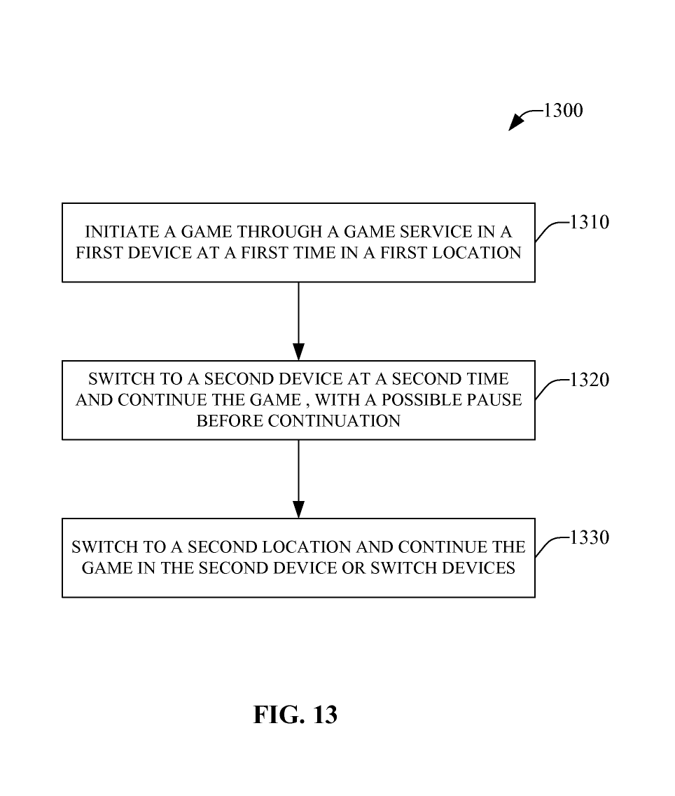

FIG. 13 is a flowchart of an example method 1300 for switching devices and locations while playing a game within a connected gaming environment. At act 1310, a game is initiated through a game service in a first device and a first location. For example, a player starts a game in a game console in a basement in the player's house. It should be appreciated that while game play is conveyed to the first device, e.g., through a controller, the game can be executed in the game service in a manner that is optimized for the player's first device, and streamed to the first device, as discussed in example method 1200 and FIG. 1. At act 1320, the first device is switched to a second device at a second time and the game is continued in the second device possibly after a pause; for example, the player switches from the game console to a desktop computer set up with multiple monitors that can facilitate playing the game with other players connected to the game service who are also playing the game—each monitor can display the game instances associated with the other players. In an aspect, a communication framework associated with the game service ensures connectivity among the players.

At act 1330, the first location is switched to a second location while continuing playing in the second device or switching the game device. In an aspect, a player can employ a detachable un-tethered controller to move from the location where the desktop computer is into a vehicle without interrupting the game. In an aspect, replica gaming (see FIG. 1 and description thereof) can ensure soft handoff of the game from the first device to the second device, and displacement from a first location to a second location.

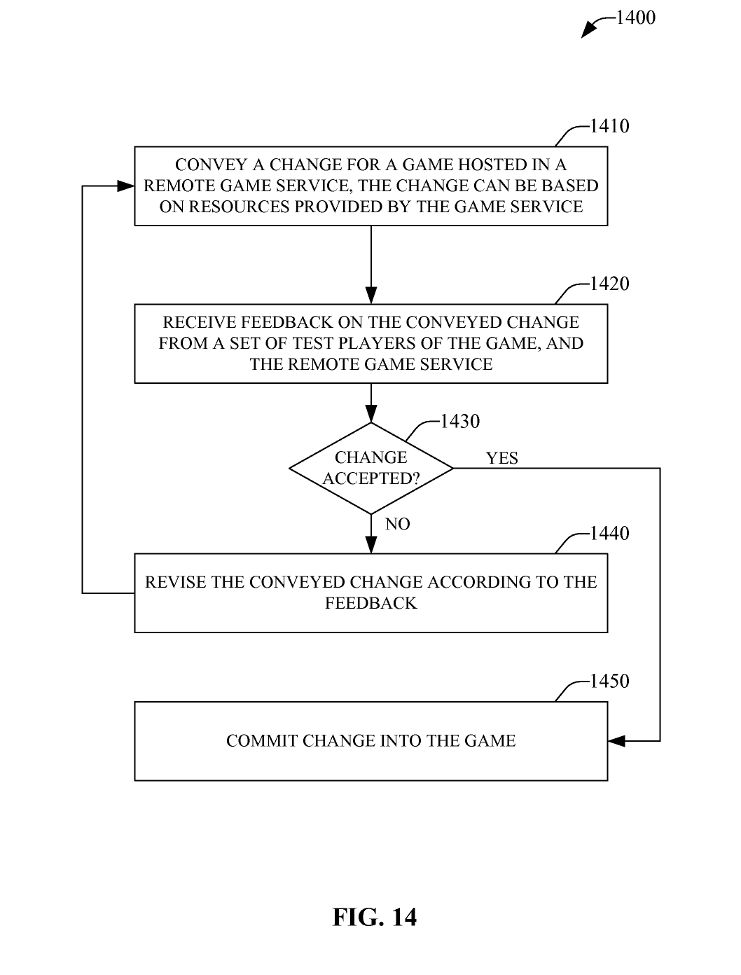

FIG. 14 presents a flowchart of a method 1400 for developing a game within a connected gaming environment. At act 1410 a change for a game hosted in a game service is conveyed, the change can be based at least in part on resources provided by the game service (e.g., resources 725). Said resources can include music fragments (e.g., contained in a music store 734), which can be employed in a change in order to elicit stronger or milder reactions in players of the game in specific portions of the game. In an aspect, a change can be conveyed, and implement by the game service in real time. The latter can be facilitated by employing available templates or features in a template store 731 or feature store 728, respectively. It should be appreciated that a conveyed change can be directed toward one or more layers of game design, e.g., primary level or atomic layer, mission statement, or mechanic layer. A change can be conveyed in real time. In another aspect, the game service can determine policies for conveying real-time changes; for instance, policies based on a player's reputation (see FIG. 6). At act 1420, feedback on the conveyed change is received from a set of test players and the game service. The feedback can also be received in real time. Test players can be part of the game community, and can receive the changes in real time through a communication framework (e.g., communication framework 190). Feedback from the game service can include supplementary changes that can promote overall game consistency in view of the proposed change, as well as enhancements to the proposed change in view of the game community profile (asserted by player intelligence associate with each player in the community), such as using a specific piece of music to better match the modified appearance of a game character. Such feedback can arise, for example, from an optimization component 135.

Act 1430 is a validation act that checks whether a change has been accepted. Acceptance can be at the community level, through the test players, or at the game service level. In an aspect, in community driven efforts, game service acceptance can be limited to accept or reject changes based on the suitability of the change for a specific audience, as well as source code consistency. In another aspect, acceptance at the game service level can be based on marketability of the change, and preservation of the game quality and premise. In case a change is rejected, the conveyed is revised according to the feedback at act 1440 and flow is returned to act 1410. Once a change is accepted, it is committed in the game service and becomes part of the game.

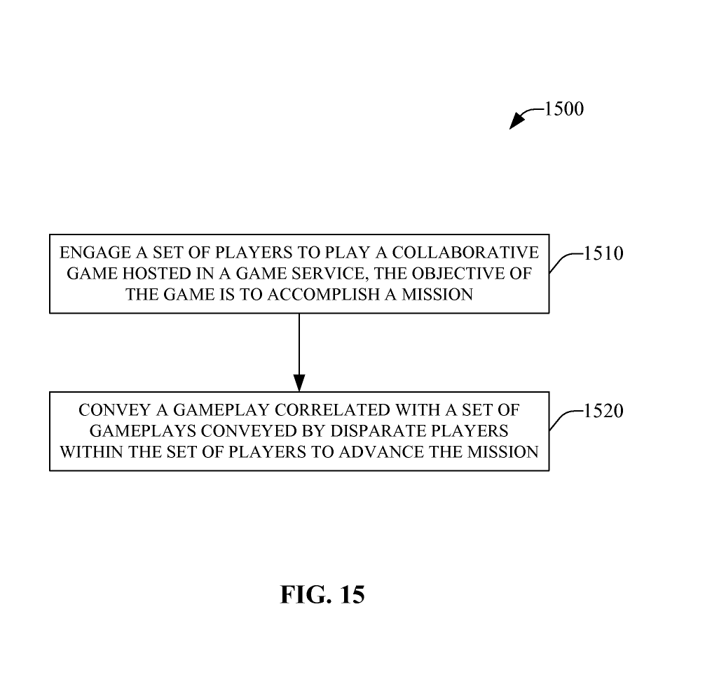

FIG. 15 is a flowchart of an example method 1500 for developing inter-personal skills through the accomplishment of a mission among multiple players in a connected gaming environment. At act 1510, a set of players is engaged to play a collaborative game hosted by a game service, wherein the objective of the game is to accomplish a specific mission. Players can be engaged through a communication framework (e.g., communication framework 190), via a short message service communication, a peer-to-peer instant messaging, or VOIP call, or by broadcasting an invitation to participate in a game from the game service. It should be appreciated that a player can be engaged regardless of the device the player has registered to play in the game service. It is noted that even though the game is collaborative and aims at developing inter-personal skills, the mission can be disjointed; for example, a first group of players's goal can be to negotiate the lowest price of an item, whereas the goal of a second group of players can be to maximize profit from a commercial transaction with the first group. Generally, a mission aims at honing social and soft skills.

At act 1520, a gameplay is conveyed to advance the mission. The gameplay is correlated with a set of gameplays conveyed by disparate participants within the set of engaged participants—here, correlated gameplay refers to a gameplay developed as a response to or through mutual agreement with a disparate gameplay. Gameplays are accessed by all engaged players through the communication framework associated with the game service hosting the game.

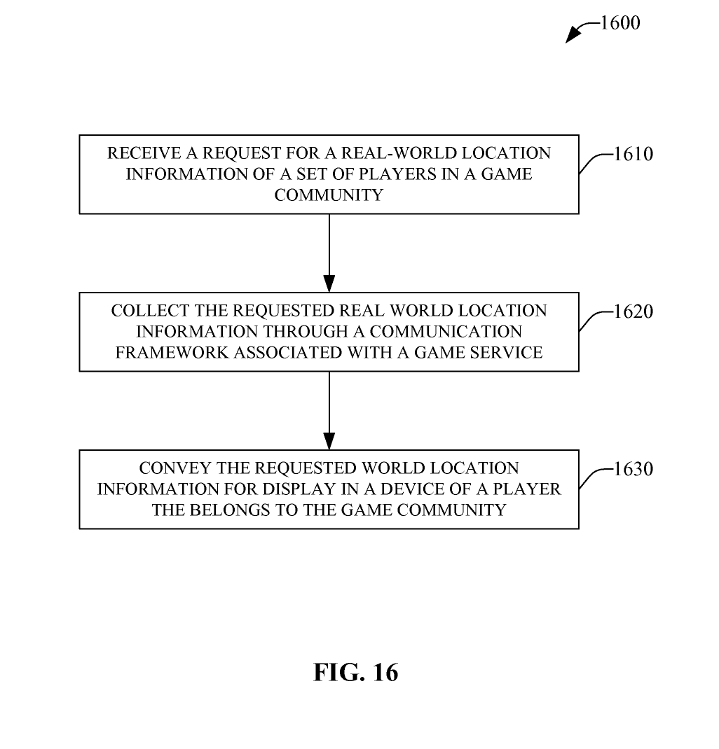

FIG. 16 presents a flowchart of an example method 1600 for identifying real-world positioning of a set of players within a game community. At step 1610, a request for real-world location information of a set of players within a game community is received. In an aspect, the set of players to be located is determined by a requesting player. As an example, such a request can be placed in order to receive a snapshot of activities associated with the set of players, e.g., players are at work, in a park, in a bar, in a church, in a Seattle Seahawks football game, and so forth. Tracking of location can be accomplished through a communication framework employed for connected gaming by a game service (FIG. 11). At step 1620, real-world location information is collected through said communication framework, and at act 1630 the information is conveyed for display in a device used for gaming by a player who requested the real-world location information. It is to be appreciated that in cases a device a player is using does not possess a display, location information can be conveyed by aural means, such as VOIP. When a player has requested the information from a device registered with the game service, but the player is not engaged in gaming, an alert can be sent to an active device of said player. It should be appreciated that by registering devices a player can have always-on connectivity with fellow players, or associates, and the game service. It is noted that method 1600 can be employed to locate associates of a player other than fellow players within a game community (FIG. 11 and related description).

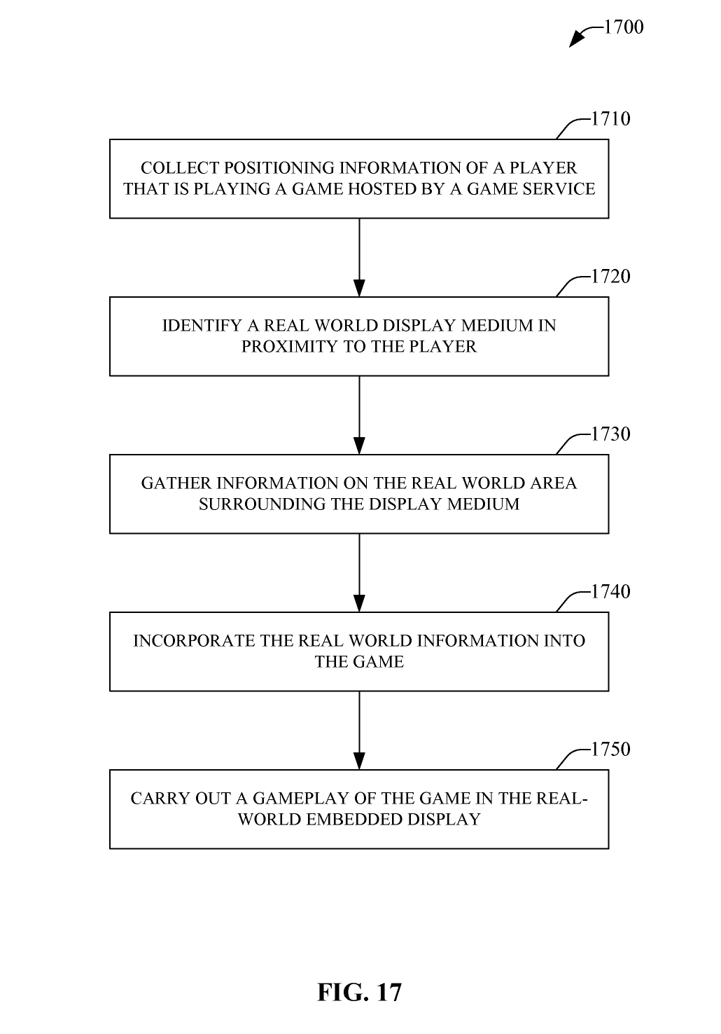

FIG. 17 presents a flowchart of an example method 1700 for real-world embedding a game within a connected gaming environment. At step 1710, positioning information of a user playing a game hosted by a game service is collected. At step 1720, a real-world display medium, e.g., an outdoor sign or a mobile roadside sign, is identified, in proximity to the player is identified. In an aspect, such signs can be connected to a communication framework that is accessible by the game service (or it is actually provided by, or associated with, the game service). At step 1730, information on the area surrounding the real-world display medium is gathered. In an aspect, such information can be collected through cameras installed in the neighborhood of the display medium. At step 1740, the real-world information is incorporated into the game played by the user whose real-world position has been identified. In an aspect, such incorporation can be accomplished by first tagging the real-world information with metadata, and then incorporating such metadata into the classes that make up the game source code. It should be appreciated that real-world information can modify the design layer of levels in a game, rather than affecting the mechanics layer. Typically, in a component-oriented, design classes with its corresponding methods belong to a design module and game modification can be performed automatically and dynamically by isolating the design module and re-compiling the game in real-time. In an aspect such modifications can be implemented by a code management component 135 (FIGS. 1 and 2). At step 1750, gameplay of the modified, real-world embedded game is carried out in the located real-world embedded displays.

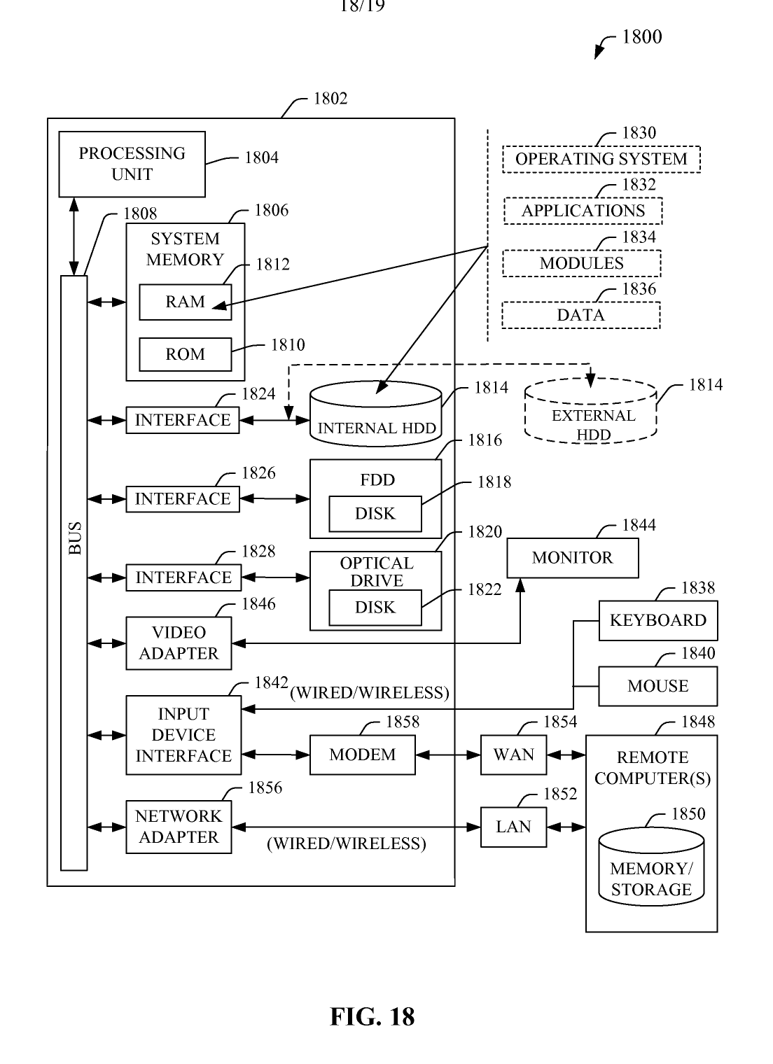

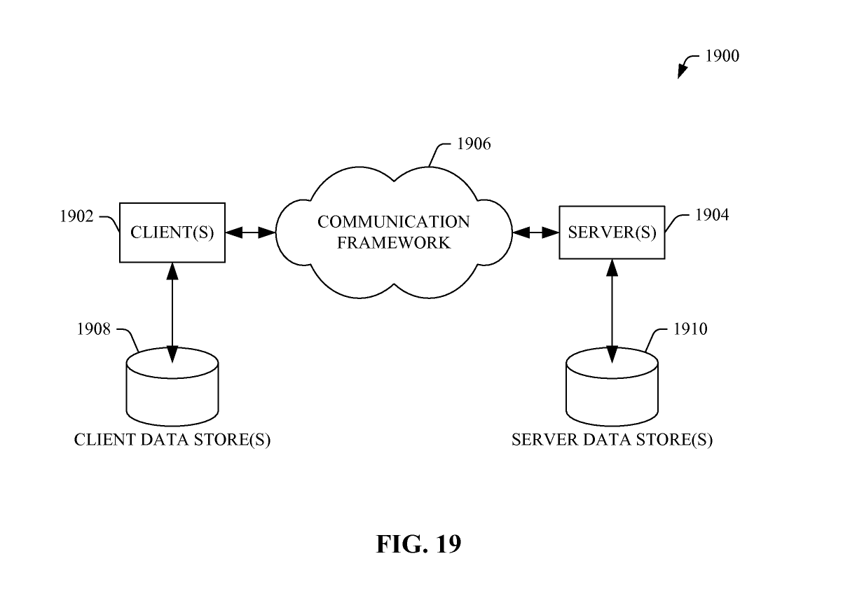

In order to provide additional context for various aspects of the subject specification, FIGS. 18 and 19 and the following discussions are intended to provide a brief, general description of a suitable computing environment 1800 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

In FIG. 18, the example environment 1800 for implementing various aspects of the specification includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures may also be employed as the processing unit 1804.

The system bus 1808 can be any of several types of bus structure that may further interconnect to a memory bus (with or without a memory controller), a peripheral bus, and a local bus using any of a variety of commercially available bus architectures. The system memory 1806 includes read-only memory (ROM) 1810 and random access memory (RAM) 1812. A basic input/output system (BIOS) is stored in a non-volatile memory 1810 such as ROM, EPROM, EEPROM, which BIOS contains the basic routines that help to transfer information between elements within the computer 1802, such as during start-up. The RAM 1812 can also include a high-speed RAM such as static RAM for caching data.

The computer 1802 further includes an internal hard disk drive (HDD) 1814 (e.g., EIDE, SATA), which internal hard disk drive 1814 may also be configured for external use in a suitable chassis (not shown), a magnetic floppy disk drive (FDD) 1816, (e.g., to read from or write to a removable diskette 1818) and an optical disk drive 1820, (e.g., reading a CD-ROM disk 1822 or, to read from or write to other high capacity optical media such as the DVD). The hard disk drive 1814, magnetic disk drive 1816 and optical disk drive 1820 can be connected to the system bus 1808 by a hard disk drive interface 1824, a magnetic disk drive interface 1826 and an optical drive interface 1828, respectively. The interface 1824 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. It is appreciated that the specification can be implemented with various commercially available operating systems or combinations of operating systems.

A user can enter commands and information into the computer 1802 through one or more wired/wireless input devices, e.g., a keyboard 1838 and a pointing device, such as a mouse 1840. Other input devices (not shown) may include a microphone, an IR remote control, a joystick, a game pad, a stylus pen, touch screen, or the like. These and other input devices are often connected to the processing unit 1804 through an input device interface 1842 that is coupled to the system bus 1808, but can be connected by other interfaces, such as a parallel port, an IEEE 1394 serial port, a game port, a USB port, an IR interface, etc.

A monitor 1844 or other type of display device is also connected to the system bus 408 via an interface, such as a video adapter 1846. In addition to the monitor 444, a computer typically includes other peripheral output devices (not shown), such as speakers, printers, etc.

The computer 1802 may operate in a networked environment using logical connections via wired and/or wireless communications to one or more remote computers, such as a remote computer(s) 1848. The remote computer(s) 1848 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1850 is illustrated. The logical connections depicted include wired/wireless connectivity to a local area network (LAN) 1852 and/or larger networks, e.g., a wide area network (WAN) 1854. Such LAN and WAN networking environments are commonplace in offices and companies, and facilitate enterprise-wide computer networks, such as intranets, all of which may connect to a global communications network, e.g., the Internet.

When used in a LAN networking environment, the computer 1802 is connected to the local network 1852 through a wired and/or wireless communication network interface or adapter 1856. The adapter 1856 may facilitate wired or wireless communication to the LAN 1852, which may also include a wireless access point disposed thereon for communicating with the wireless adapter 1856.

When used in a WAN networking environment, the computer 1802 can include a modem 1858, or is connected to a communications server on the WAN 1854, or has other means for establishing communications over the WAN 1854, such as by way of the Internet. The modem 1858, which can be internal or external and a wired or wireless device, is connected to the system bus 1808 via the serial port interface 1842. In a networked environment, program modules depicted relative to the computer 1802, or portions thereof, can be stored in the remote memory/storage device 1850. It will be appreciated that the network connections shown are example and other means of establishing a communications link between the computers can be used.

The computer 1802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

FIG. 19 illustrates a schematic block diagram of a computing environment in accordance with the subject specification. The system 1900 includes one or more client(s) 1902. The client(s) 1902 can be hardware and/or software (e.g., threads, processes, computing devices). The client(s) 1902 can house cookie(s) and/or associated contextual information by employing the specification, for example.

The system 1900 also includes one or more server(s) 1904. The server(s) 1904 can also be hardware and/or software (e.g., threads, processes, computing devices). The servers 1904 can house threads to perform transformations by employing the specification, for example. One possible communication between a client 1902 and a server 1904 can be in the form of a data packet adapted to be transmitted between two or more computer processes. The data packet may include a cookie and/or associated contextual information, for example. The system 1900 includes a communication framework 1906 (e.g., a global communication network such as the Internet) that can be employed to facilitate communications between the client(s) 1902 and the server(s) 1904.

Communications can be facilitated via a wired (including optical fiber) and/or wireless technology. The client(s) 1902 are operatively connected to one or more client data store(s) 1908 that can be employed to store information local to the client(s) 1902 (e.g., cookie(s) and/or associated contextual information). Similarly, the server(s) 1904 are operatively connected to one or more server data store(s) 1910 that can be employed to store information local to the servers 1904.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . optical disks [e.g., compact disk (CD), digital versatile disk (DVD) . . . ], smart cards, and flash memory devices (e.g., card, stick, key drive . . .

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates a connected gaming experience among multiple users and a plurality of devices containing a first device and a second device, the system comprising:
a registration component that registers the first device, the registration component registers the second device;
an optimization component that optimizes a code of a game for gameplay in the first registered device;
a virtualization component that executes the optimized game on a virtual instance of the first registered device and delivers content of the game to the first registered device, said virtualization component facilitates switching gameplay from the first registered device to the second registered device; and
the optimization component optimizes the code of the game for gameplay in the second registered device.

2. The system of claim 1, further comprising a code management component that reduces a plurality of classes and associated metadata in the game's code to a plurality of device-independent code assemblies that provide gameplay and game features.

3. The system of claim 2, the code management component comprises a compilation component that compiles the code assemblies associated with the game's code.

4. The system of claim 1, the registration component further comprises a security component that registers a player and collects information that characterizes the player.

5. The system of claim 4, the security component further authenticates a registered player, wherein the authentication employs at least one of an encrypted password, a voice signature, or a sound sequence.

6. The system of claim 1, further comprising a customization component that allows to modify a game, the customization component comprising a set of development tools accessible through the device associated with the player.

7. The system of claim 1, wherein the content of the game is delivered to the first device and second device through a communication framework that comprises at least one of a local area network, a wide area network, and a global positioning system.

8. The system of claim 7, wherein the communication framework facilitates to convey a development to the game by a set of registered players and to receive feedback on the development from a set of registered test players.

9. The system of claim 7, wherein the communications framework facilitates to identify a real-world location of the player, and the game content delivered to the device associated with the player incorporates space context retrieved from a location in proximity to the player.

10. The system of claim 8, wherein the communication framework facilitates to convey real-world location information of a set of associates related to the player, and facilitates to communicate with a member of the set of associates.

11. A computer-implemented method for playing a game within a connected gaming environment, the method comprising:
registering a device in a remote game service for playing a game stored thereon;
optimizing a code of the game for the resources available to the registered device;
conveying audiovisual elements of the optimized game to the registered device; and
receiving a gameplay from the registered device.

12. The method of claim 11, further comprising:
initiating the game stored in the remote game service in a first device at a first time in a first location;
switching to a second device at a second time and continuing the game; and
switching to a second location and continuing the game at the second device.

13. The method of claim 12, wherein switching to a second device at a second time and continuing the game includes making a pause before continuing the game.

14. The method of claim 11, further comprising:
conveying a change for the game stored in the remote game service, wherein the change can be based at least in part on resources provided by the remote game service;
receiving feedback on the conveyed change from a set of test players and the remote game service; and
committing the conveyed change, if the conveyed change is accepted, or revising the conveyed change otherwise.

15. The method of claim 14, wherein the change is directed toward one or more layers of game design, and conveyed in real time.

16. The method of claim 14, wherein receiving feedback on the conveyed change from a set of test players and the remote game service includes at least one of a supplementary change that promotes game consistency, or an enhancement to the conveyed change according to a game community profile.

17. The method of claim 11, further comprising:
engaging a set of players to play a collaborative game hosted in the remote game service; and
conveying a gameplay correlated with a set of gameplays conveyed by disparate players within the set of player to advance the collaborative game's mission.

18. The method of claim 16, engaging the set of players includes conveying at least one of a short message service communication, a peer-to-peer instant message, or a voice over internet protocol call.

19. A system that operates in a connected gaming environment, the system comprising:
means for collecting positioning information of a player that is playing a game hosted by a computer-implemented game service;
means for identifying a real-world display medium in proximity to the player;
means gathering information on the real-world area surrounding the display medium;
means for incorporating the real-world information into the game; and
means for carrying out gameplay of the modified game in the real-world embedded display.

20. The system of claim 19, further comprising:
means for receiving a request for a real-world location information of a set of players in a game community;
means for collecting the requested real-world location information; and
means for conveying the requested real-world location information for display on a registered device of player that belongs to the game community.
